(19) United States
(12) Patent Application Publication
(10) Pub. No.: US 2010/0193620 A1
(43) Pub. Date: Aug. 5, 2010

(54) MOBILE LIFT AND CHIPPER UNIT

(76) Inventor: DENNIS A. ANDERSON, Kent, OH (US)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(21) Appl. No.: 12/365,439

(22) Filed: Feb. 4, 2009

(51) Int. Cl. B02C 19/20

(52) U.S. Cl. 241/101.741; 241/73

(57) ABSTRACT

A chipper mounted aerial unit for tree trimming and removal includes a truck having a cab and bed frame. An aerial unit including a hydraulic arm and lift bucket are attached to the bed frame. A chipper unit is attached at and end of the bed frame opposite the truck cab, and has a feed chute angled with respect to a discharge chute, the discharge chute being in substantial alignment with a main longitudinal axis of the truck. A chip box trailer is connected by means of a hitch to the bed frame and is positioned to receive debris in the form of chipped wood and the like from the discharge chute of the chipper. The chip box trailer may be quickly removed from a hitch on the bed frame and transported to a disposal area by another vehicle, while another chip box trailer is positioned for continued receipt of debris from the chipper, minimizing down time and improving operator safety by allowing the operator to stand out of the roadway while feeding the angled feed chute.

### TECHNICAL FIELD

The invention herein resides in the art of mobile units or devices adapted for providing on-site work, while being readily transported to and from the work site. More particularly, the invention relates to a truck having a selectively interconnected trailer assembly, both the truck and trailer being adapted for implementation in the work effort. More specifically, the invention relates to a mobile lift and chipper unit particularly suited for tree trimming and removal, wherein the unit includes a truck providing a lift mechanism and chipper assembly, and a trailer removably attachable to the truck, the trailer being particularly adapted for receiving debris in the form of wood chips from the chipper assembly. The trailer is adapted for ease of coupling and decoupling from the truck, allowing the truck to remain on the job site while the trailer is separately transported to a waste area where it may be emptied.

### BACKGROUND ART

Truck units for use in tree trimming and removal are now commonly known. Typically, such truck units include a truck having a cab and bed frame, the bed frame having a chip box fixedly secured thereto, along with a hydraulic lift arm and bucket mechanism for lifting workers into proximity of tree portions intended for removal. This truck and chip box unit has also typically included a mobile chipper unit adapted for coupling and decoupling thereto by means of a trailer hitch on the truck unit and an extended tongue and ball receiver on the chipper unit. When using the prior art devices, the truck and chipper unit were driven to the job site together, and once the chip box attached to the bed frame was filled with debris and wood chips, the chipper unit was detached therefrom and the truck unit was driven to a dumping area, where the chip box was emptied. Until the truck and attached chip box were returned to the job site, the hydraulic lift arm and bucket assembly, as well as the chipper unit that was left at the job site, were incapable of use for disposal of removed tree parts. Accordingly, a significant downtime was experienced.

A prior art chipper truck unit is shown in FIG. 1 and designated generally by the numeral 10. The prior art structure includes a truck 12 having a tractor or cab portion 14 and a fixedly attached chip box portion 16, the entire truck being transportable by an engine, transmission and wheel structure as well known to those skilled in the art. The chip box portion 16 of the prior art comprised an enclosed cavity accessed through the rear by means of doors or a partial-height opening, as commonly understood. The chip box portion 16 was mounted upon a bed frame 18 securedly attached to, and often integral with, the tractor cab portion 14. A wheel mounted chipper unit 20, as readily known and understood to those skilled in the art, was selectively attachable to a trailer hitch 22 that was in turn secured to the bed frame 18. A tongue 24 of the chipper unit 20, having a ball receiver at an end thereof, provided means for selectively engaging the chipper unit 20 to the truck 12 for towing to and from job sites.

As readily understood by those skilled in the art, the chipper unit 20 included a feed chute 26, in operative communication with a chipper section 28, which in turn was in output communication with an discharge chute 30. According to prior art structures, the input axis of the feed chute 26 and the output axis of the discharge chute 30 were typically aligned or substantially in plane with each other, and orthogonal to the operational axis of the chipper section 28. The chipper section 28 included a power pack, such that the unit 20 was totally self contained, but the associated power pack required frequent attention and servicing.

In the prior art unit 10, the truck 12 was also typically provided with a hydraulic lift arm assembly 32, the lift arm assembly 32 often being of a telescoping type. At the end of the lift arm assembly 32 was a bucket 34 for safely receiving and elevating a worker having a chainsaw or other implements for trimming and removing elevated tree parts.

According to the prior art, with the trailer 16 being fixedly mounted to the bed frame 18 of the truck 12, numerous inefficiencies were experienced. To begin, this type of structure typically requires a driver having a special license for actually driving the unit upon the highway in various jurisdictions. Moreover, when the truck 12 was transported from the job site to a disposal area, the hydraulic lift arm 32 and bucket 34 were no longer available for use, resulting in significant downtime. Even the chip box 16 was unavailable such that the chipper unit 20 could not be used, despite the fact that it was self contained and left at the job site. Further problems with the prior art structure included risks inherent with an inline feed chute 26 and discharge chute 30. When trimming or removing trees along a roadway, the workers would necessarily be required to stand in the street to feed tree branches and the like into the feed chute 26, subjecting them to risks of vehicle injuries.

There is a need in the art for an improvement over such prior systems, increasing the efficiency of their implementation and safety in their use.

### DISCLOSURE OF INVENTION

In light of the foregoing, it is a first aspect of the invention to provide a chipper mounted aerial unit for tree trimming and removal in which the chipper unit is mounted to the bed frame of the truck and the chip box is selectively and removably attached as a pull behind trailer.

Other aspects of the invention are achieved by a chipper mounted aerial unit for tree trimming and removal in which the chipper unit and chip box portion of the truck are interchanged with each other as to position and mobility.

A further aspect of the invention is achieved by the provision of a chipper mounted aerial unit for tree trimming and removal in which the feed chute and discharge chute of the chipper unit are not aligned with each other.

Still a further aspect of the invention is the provision of a chipper mounted aerial unit for tree trimming and removal in which the feed chute is angled with respect to the discharge chute, such that workers may stand out of the roadway when introducing tree portions thereinto.

Still a further aspect of the invention is the provision of a chipper mounted aerial unit for tree trimming and removal in which the chip box for receiving debris in the form of chipped wood and the like may be readily transported to and from the job site by a vehicle other than the chipper mounted aerial unit, and in which various chip box trailers may be used in association with a single chipper mounted aerial unit.

Yet another aspect of the invention is the provision of a chipper mounted aerial unit for tree trimming and removal that employs a chipper that may be driven by a PTO from an associated truck, eliminating the need of a separate power pack.

Further aspects of the invention are attained by a chipper mounted aerial unit for tree trimming and removal which, in most jurisdictions, does not require a special drivers license to operate on the roadways.

A further aspect of the invention is the provision of a chipper mounted aerial unit for tree trimming and removal that is economical in use and easy to construct using presently known elements and techniques.

The foregoing and other aspects of the invention that will become apparent as the detailed description proceeds are achieved by a mobile lift and chipper unit for tree trimming and removal, comprising: a truck having a bed frame; and a chipper unit attached to and received upon one end of the said bed frame, said chipper unit having a feed chute and an discharge chute, said feed chute and discharge chute being offset with respect to each other.

Other aspects of the invention are attained by a mobile lift and chipper unit for tree trimming and removal, comprising: a truck cab; a truck bed frame connected to said truck cab, said truck cab and bed frame having a common longitudinal axis; a chipper unit received upon said bed frame at an end thereof opposite said cab, said chipper unit comprising and inlet chute at an angle to said longitudinal axis, and a discharge chute substantially parallel to said longitudinal axis; and a chip box trailer removably connected to said end of said bed frame and aligned with said discharge chute to receive material therefrom.

### DESCRIPTION OF DRAWINGS

For a complete understanding of the objects, techniques and structure of the invention, reference should be made to the following detailed description and accompanying drawings wherein:

FIG. 1 is a side elevational view of a prior art structure;

FIG. 2 is a side elevational view of the chipper mounted aerial unit of the invention; and

FIG. 3 is a top plan schematic view showing the truck bed frame and connected chipper frame, along with the power takeoff drive mechanism between the truck and chipper unit.

### BEST MODE AND PREFERRED EMBODIMENT

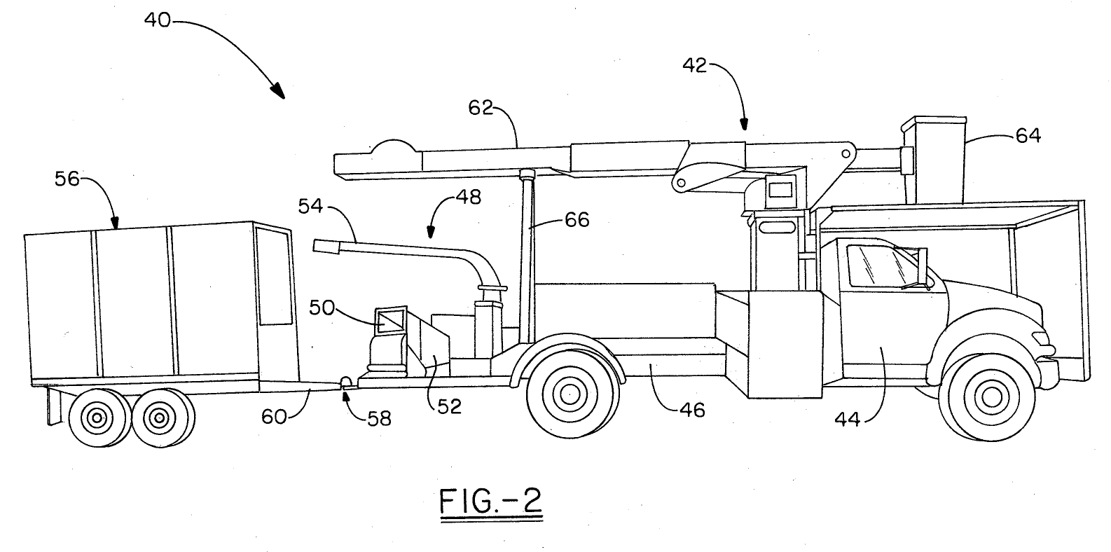

Referring again to the drawings and more particularly FIG. 2, it can be seen that a chipper mounted aerial unit made in accordance with the invention is designated generally by the numeral 40. The unit 40 includes a truck 42 having a tractor cab 44 at a front end thereof, with an attached bed frame 46 extending rearwardly therefrom. The bed frame 46 typically includes a pair of rails or beams that extend to receive a chipper unit 48 mounted at the end thereof opposite tractor cab 44. The chipper unit 48 includes a feed chute 50 angled with regard to the longitudinal axis of the truck 42. The feed chute and truck axis are preferably angled on the order to between 30° and 60°, and most preferably at an angle of 45°. The feed chute 50 communicates with a chipper section 52, in common fashion. The discharge chute 54 is in operative communication with the chipper section 52 and is preferably parallel to the longitudinal axis of the truck 42. Accordingly, the feed chute 50 and discharge chute 54 are angled with respect to each other on the order of 30°-60°, and preferably 45°.

A wheeled chip box trailer 56 is removably connected to the bed frame 46 by means of a trailer hitch 58. The trailer hitch 58 is secured to the bed frame 46 and is adapted to interconnect with a ball receiver on the end of tongue 60 connected to and extending from a frame of the wheeled chip box trailer 56.

A hydraulic arm and bucket assembly is fixedly secured to the bed frame 46 of the truck 42. Again, this system includes a hydraulic arm 62 which is preferably of a scissors and telescoping type. At the end of the hydraulic arm 62 is a bucket 64 for receiving, elevating and otherwise moving a worker to a desired position for working on a tree within a tree area. A support post 66 is also connected to the bed frame 46, near the chipper unit 48, for purposes of supporting and end of the hydraulic arm 62, as shown. Preferably, the support post 66 is triangular in nature, with a pair of legs extending from opposite sides of the bed frame 46.

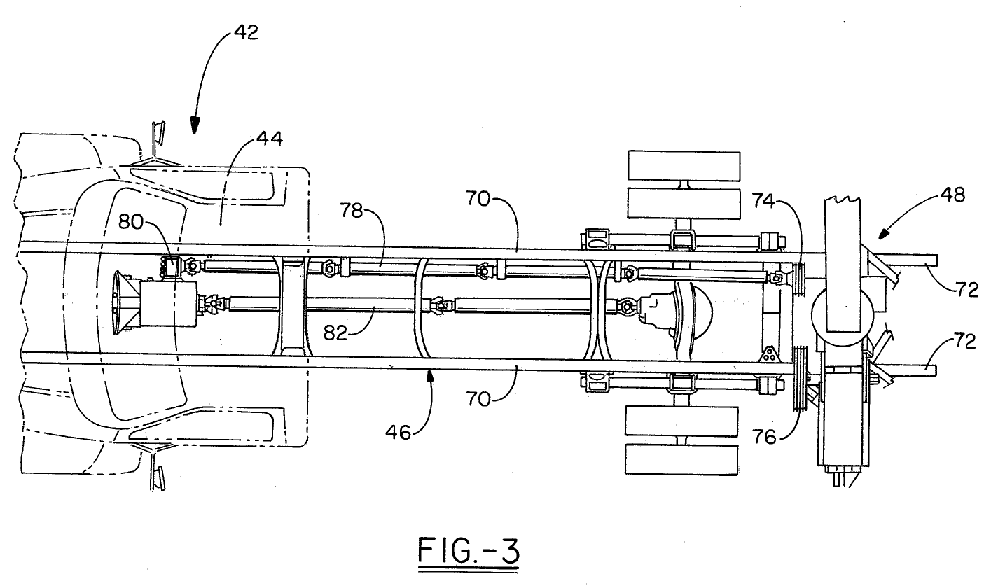

With reference to FIG. 3, it can be seen that the truck 42 includes a truck tractor or cab 44 connected to a bed frame 46 having a chipper unit 48 attached at an end thereof opposite the cab 44. The frame 46 preferably comprises a pair of beams or rails 70.

The chipper unit 48 is shown in FIG. 3 as just a frame assembly, without specifics of the feed chute 50, chipper section 52 and discharge chute 54. The chipper unit includes a frame assembly, primarily comprising beams or rails 72, adapted to support a deck (not shown) for maintaining the chipper unit 48. These beams or rails 72 are bolted, welded, or otherwise fixed to beams or rails 70.

The chipper unit 48 includes a pair of belt sheaves, including a drive belt sheave 74 and a driven belt sheave 76, as well known to those skilled in the art. The driven belt sheave 76 is connected to and drives the chipper section 52 of the chipper 48. The drive belt sheave 74 is connected to and driven by an extended power take-off (PTO) shaft 78, which extends to the power takeoff unit 80 connected to and driven by the engine of the truck 42. The power takeoff shaft 78 is, as shown, parallel to the truck drive shaft 82. Accordingly, those skilled in the art will appreciate that the power takeoff unit 80 drives the sectioned power takeoff shaft 78, to drive the drive belt sheave 74 which, in turn, through a belt (not shown) drives the driven belt sheave 76, for driving the chipper section 52. Accordingly, the need for an independent self-contained power pack to drive the chipper section 52 is eliminated, along with its costs of service and maintenance.

With an appreciation of the structure just presented, it will be understood that a chip box trailer 56 may be transported to an from the work site other than by the truck 42. The chip box trailer 56 may be transported by means of a pickup truck or similar vehicle, and multiple trailers may be employed such that no down time of the truck unit 42, including the chipper unit 48 and aerial unit 62, 64 will be experienced. With one or more chip box trailers provided at the job site, and with another vehicle of common type readily available for transporting the trailers, no down time is experienced. Additionally, with the feed chute 50 being angled with regard to the discharge chute 54, workers may stand safely out of the roadway while feeding material and debris into the chute 50. It is contemplated that the angle of the chute 50 may, indeed, be adjustable to accommodate the safest positioning for workers in any particular area. In any event, only the truck 42 and chip box trailer 56 will be on any roadway, these structures actually shielding workers from vehicles using the roadway.

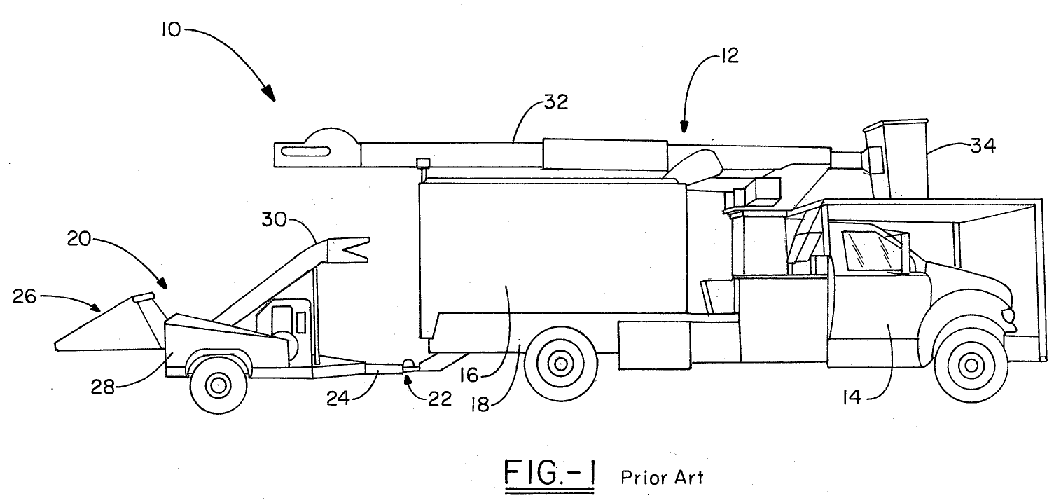

It will be readily appreciated that only minor modifications to the prior art of FIG. 1 are required to achieve the significant benefits of the invention. The chipper unit 48 and chip box trailer unit 50 are readily available and easily adapted for implementation in accordance with the invention. Such minor modifications and adaptations result in significant improvements in efficiency of operation, reduced down time, and operator safety.

Thus it can be seen that the various aspects of the invention have been attained by the structure presented and described above. While in accordance with the patent statutes only the best known and preferred embodiments of the invention have been presented and described in detail, the invention is not limited thereto or thereby. Accordingly, for an appreciation of the true scope and breadth of the invention reference should be made to the following claims.

What is claimed is:

1. A mobile lift and chipper unit for tree trimming and removal, comprising:
a truck having a bed frame; and
a chipper unit attached to and received upon one end of the said bed frame, said chipper unit having a feed chute and a discharge chute, said feed chute and discharge chute being offset with respect to each other.

2. The mobile lift and chipper unit for tree trimming and removal according to claim 1, wherein said discharge chute is in substantial alignment with a longitudinal axis of said bed frame.

3. The mobile lift and chipper unit for tree trimming and removal according to claim 2, wherein said bed frame has a trailer hitch attached to said one end, said trailer hitch selectively coupling a chip box trailer in refuse receiving alignment with said discharge chute.

4. The mobile lift and chipper unit for tree trimming and removal according to claim 3, wherein said chipper unit further comprises a chipper section interposed between said feed chute and discharge chute.

5. The mobile lift and chipper unit for tree trimming and removal according to claim 4, wherein said chipper unit is maintained upon a chipper frame, said chipper frame being fixed to said bed frame of said truck.

6. The mobile lift and chipper unit for tree trimming and removal according to claim 5, wherein said truck further comprises a power take-off unit, and further comprising a shaft operatively interconnected between said power take-off unit and said chipper unit.

7. The mobile lift and chipper unit for tree trimming and removal according to claim 6, further comprising a hydraulic arm and bracket assembly mounted by said truck.

8. The mobile lift and chipper unit for tree trimming and removal according to claim 7, further comprising a post extending upwardly from said bed frame for supporting said hydraulic arm and bucket.

9. The mobile lift and chipper unit for tree trimming and removal according to claim 4, wherein said feed chute and discharge chute are angled with respect to each other between 30 and 60 degrees.

10. The mobile lift and chipper unit for tree trimming and removal according to claim 9, wherein said feed chute and discharge chute engage said chipper portion at a separation angle of 45 degrees.

11. The mobile lift and chipper unit for tree trimming and removal according to claim 10, wherein said feed chute has an opening on a curb side of said truck.

12. The mobile lift and chipper unit for tree trimming and removal according to claim 11, wherein said separation angle is adjustable.

13. The mobile lift and chipper unit for tree trimming and removal according to claim 9, wherein said chipper frame is connected to said bed frame behind a rear axle of said truck.

14. The mobile lift and chipper unit for tree trimming and removal according to claim 13, wherein said chip box trailer has an opening in alignment with said discharge chute.

15. A mobile lift and chipper unit for tree trimming and removal, comprising:
a truck cab;
a truck bed frame connected to said truck cab, said truck cab and bed frame having a common longitudinal axes;
a chipper unit received upon said bed frame at an end thereof opposite said cab, said chipper unit comprising and inlet chute at an angle to said longitudinal axis, and a discharge chute substantially parallel to said longitudinal axis; and
a chip box trailer removably connected to said end of said bed frame and aligned with said discharge chute to receive material therefrom.

16. The mobile lift and chipper unit for tree trimming and removal according to claim 15, further comprising a truck hitch for said removable connection.

17. The mobile lift and chipper unit for tree trimming and removal according to claim 16, wherein axes of said inlet chute and discharge chute are offset between 30 degrees and 60 degrees.

18. The mobile lift and chipper unit for tree trimming and removal according to claim 17, further comprising a hydraulic arm and bucket received by said truck bed and supported by a post extending from said truck bed.

19. The mobile lift and chipper unit for tree trimming and removal according to claim 18, wherein said chipper unit is connected through a drive shaft to a power take-off unit of the truck cab.

20. The mobile lift and chipper unit for tree trimming and removal according to claim 19, wherein said connection between said chipper and drive shaft is further through a belt drive system of a drive sheave connected to said drive shaft and a driven sheave spaced from said drive sheave and aligned therewith.
